(19) United States
(12) Patent Application Publication
(10) Pub. No.: US 2018/0319642 A1
(43) Pub. Date: Nov. 8, 2018

(54) DETECTION SYSTEM FOR FRONT OF A VEHICLE

(71) Applicant: SUPERIOR PAK HOLDINGS PTY LTD, Queensland (AU)

(72) Inventors: Michael PRONGER, Queensland (AU); Rowland ERRINGTON, Queensland (AU)

(21) Appl. No.: 15/773,759

(22) PCT Filed: Nov. 7, 2016
(86) PCT No.: PCT/AU2016/051066

§ 371 Date: May 4, 2018

(30) Foreign Application Priority Data
Nov. 11, 2015 (AU) 2015904640

(51) Int. Cl. B66F 9/075; B60Q 9/00; B60P 1/50; B66F 17/00

(52) U.S. Cl. CPC B66F 9/0755; B66F 17/003; B60P 1/50; B60Q 9/008

(57) ABSTRACT

The present invention is a detection system for the front of a vehicle with front lift arms for lifting and lowering a bin where one or more sensors are used to detect the presence of an object or person and control means to receive and process sensor input to control the operation of the lifting arms. When the presence of the object or person is detected, the movement of the lifting arms are stopped and or an alarm is sounded.

### FIELD OF INVENTION

The present invention relates to detection systems for vehicles. The present invention has particular but not exclusive application for detection of a person or object in front of a front lifting waste collection vehicle. Reference in the specification will be made to waste collection vehicles that lift bins from the front of the vehicle, but the invention is not limited to this application.

### BACKGROUND OF THE INVENTION

Waste collection vehicles that lift a bin from the front of the vehicle are currently operated manually to lift the bin, position the bin to empty its contents and return the bin to its original position. The operator requires a high degree of concentration whilst watching and controlling the progress of the bin during the lifting and lowering stages to prevent the bin contents from being spilt, damage resulting from the bin contacting the front of the cab including the windscreen or accidental injury to a person passing in front of the vehicle while the bin is being lowered.

The typical waste bin has a volume capacity of between 1.5 and 3 cubic meters and has a rectangular pocket located near the mid-point on each outer side. The waste collection vehicle has lift arms with tines that can be positioned and inserted within the bin pockets in order to lift the bin. The lift arms are then raised hydraulically by means of electric controls using a cab-mounted joystick. The driver continually watches the bin as it is raised and maintains the bin at a horizontal aspect, controlling the angle of the bin by means of the joystick where the front to back joystick movement raises and lowers the lift arms while the left and right joystick movement tips and maintains the bin in a horizontal aspect. When the lift arms are fully elevated the bin is tipped by means of joystick movement, that is left and right joystick movements tip to empty and restore the bin to a level orientation. After tipping the driver levels the bin visually by means of the joystick, lowers the arms and replaces the bin in its original location on the ground. The lift arms are then withdrawn from the bin pockets.

The driver must at all times be assessing a number of different parameters at any one time and this degree of complexity can lead to problems as discussed above.

### OBJECT OF THE INVENTION

It is an object of the present invention to reduce the complexity of the lifting, positioning and returning of the bin of a front lifting waste collection vehicle and thereby avoid or minimize one or more of the above mentioned problems.

### SUMMARY OF THE INVENTION

The present invention was developed from considering different options to addressing the aforementioned problems, deciding on and developing a sensor detection system where the optimal positioning of the sensors were considered and the efficient integration of the sensor detection system with the lifting and operational controls determined.

In one aspect the present invention broadly resides in a detection system for the front of a vehicle with front lift arms for lifting and lowering a bin and including

one or more sensors to detect the presence of an object or person;

control means to receive and process sensor input to control the operation of the lifting arms wherein when the presence of the object or person is detected the movement of the lifting arms is stopped.

Preferably when the lifting arm is being lowered and an object or person is detected, the operation of the lifting arms is stopped.

Preferably the one or more sensors are able to detect the object or person within a defined perimeter around the front of the vehicle. More preferably the one or more sensors are able to detect the presence of the object or person and movement of the person or object within the area or space that would be covered by the returned bin. The area or space that would be covered by the returned bin forms a first zone. Preferably the one or more sensors are able to detect movement of the object when it is in a defined area or space surrounding the first zone. The defined area or space surrounding the first zone forms the second zone.

The detection system preferably defines two zones where the first zone covers the space through which a bin moves between a raised and a lowered position and a second zone is the space surrounding the first zone. Preferably the movement of the lifting arms is stopped when a person or object is detected within the first zone. Preferably the movement of the lifting arms is stopped when a person or object is moving within the second zone. In one form, an alarm is activated when a person or object is detected within the second zone. In another form, an alarm and/or a warning light is activated when a person or object is detected within the first zone and/or when a person or object is detected moving within the second zone. Preferably the alarm includes an audible alarm. Preferably the alarm includes a warning light. Preferably the warning light is a flashing light.

The control means preferably includes a programmable logic controller and or processor to process the sensor input. In one form, the sensor input preferably provides an over-riding parameter in the control of the operation of the lifting arms.

Preferably there are two sensors near each side of the front of the vehicle. The two sensors are preferably spaced apart and positioned to provide a wide uninterrupted view of most of the area or space of the first zone and the second zone. Preferably the sensors are positioned near the headlights or indicator lights at the front of the vehicle.

The control means preferably includes a programmable logic controller and/or processor to process the sensor input. Preferably the one or more sensors include two sensors that are spaced apart and positioned to provide a wide uninterrupted view of the space of the first zone and the second zone.

Preferably the detection system further includes an override input which provides an output signal. Preferably, the control means receives and processes the output signal from the override input and prevents the movement of the lifting arms being stopped. Preferably the override input is a button that can be pressed by the operator of the waste collection vehicle to override the detection system.

In another preferred embodiment there is single sensor centrally mounted on the front of the vehicle and having a broad angle view.

Preferably the one or more sensors include a motion sensor. More preferably the one or more sensors also include a proximity sensor. In another form the one or more proximity sensors include a radar sensor, an infrared sensor, a laser range finder, a photoelectric sensor and/or an ultrasonic sensor. Preferably the one or more sensors are located between 1 m and 1.5 m above a ground surface. Preferably the one or more sensors are located above front headlights of the vehicle.

In another aspect the invention broadly resides in system for lifting and lowering lift arms at the front of a vehicle using a detection system as described above, including

one or more sensors to detect the presence of an object or person;

control means to receive and process sensor input to control the operation of the lifting arms; and

actuation means to actuate the movement of the lifting arms in response to operational signals from the control means, wherein when the presence of the object or person is detected the lifting arms are stopped.

The actuation means preferably includes one or more hydraulic pistons operationally associated with each of the lift arms.

Preferably there are one or more warning signals including an audible alarm and flashing lights that alert the driver and others to the possibility of a problem when a person or object is detected by the one or more sensors.

In a further aspect the invention broadly resides in a vehicle with front lift arms for lifting and lowering a bin, the vehicle including a detection system as described above.

In another aspect the present invention broadly resides in a waste collection vehicle with front lift arms for lifting and lowering a bin, the vehicle including:

a detection system having:

one or more sensors to detect the presence of an object or person; and

control means to receive and process sensor input to control the operation of the lift arms,

wherein when the presence of the object or person is detected the movement of the lift arms is stopped.

Preferably the waste collection vehicle is a waste collection vehicle that lifts bins from a front of the vehicle.

In a further aspect, the invention broadly resides in a waste collection vehicle, including:

front lift arms for lifting and lowering a bin; and

a detection system having one or more sensors to detect the presence of an object or person, and control means to receive and process sensor input to control the operation of the lift arms,

wherein in use, when the lift arms are moving and when the presence of the object or person is detected by the one or more sensors, the one or more sensors provide sensor input to the control means, the control means processes the sensor input and stops the movement of the lifting arms.

Preferably the control means is a controller.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a diagrammatic view of a vehicle with proximity and movement sensors near the side of the front of the vehicle;

FIG. 2 is a plan view of the vehicle with the detection sensors, and

FIG. 3 is a flow diagram of the operation of the detection system of the invention.

### DETAILED DESCRIPTION OF THE PREFERRED EMBODIMENT

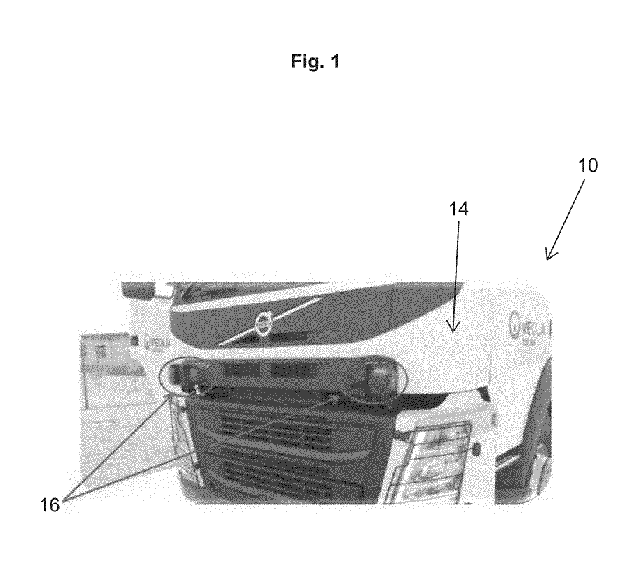

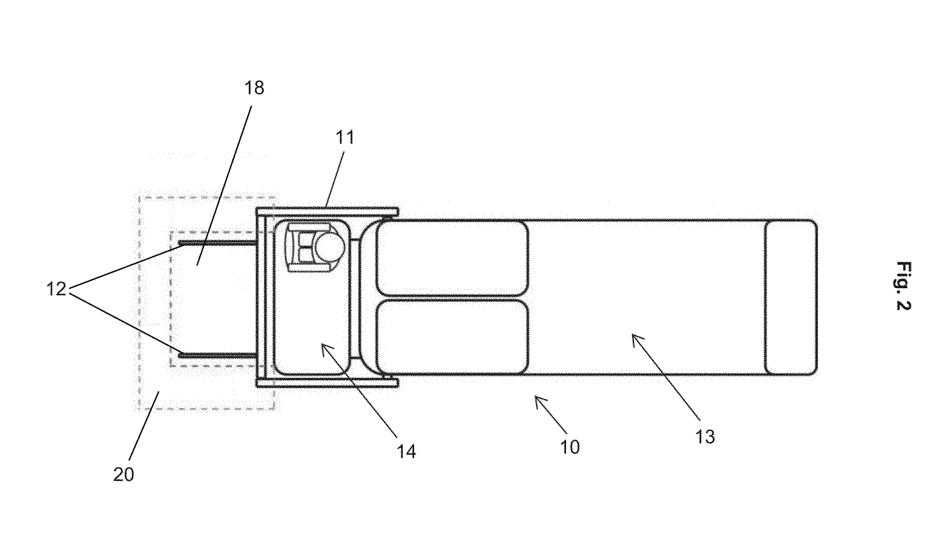

With reference to FIGS. 1 and 2, there is shown a waste collection vehicle 10 that has lifting arms 11 with two tines 12. The waste collection vehicle 10 has a hopper 13 behind the cab 14 where the driver sits, drives and operates the vehicle 10. On either side of the front of the vehicle 10 are a set of sensors 16. Each set of sensors includes a proximity sensor and a motion sensor. In another embodiment (not shown), there is an inclinometer sensor mounted on one or both of the lifting arms 11 or the tines 12.

With particular reference to FIG. 2, the area or space that would be covered by a bin (not shown) forms a first zone 18. The area or space surrounding the perimeter of the first zone 18 forms a second zone 20. The second zone 20 has a width of approximately one meter. The dimensions of the first zone 18 are preferably the length and width of the bin.

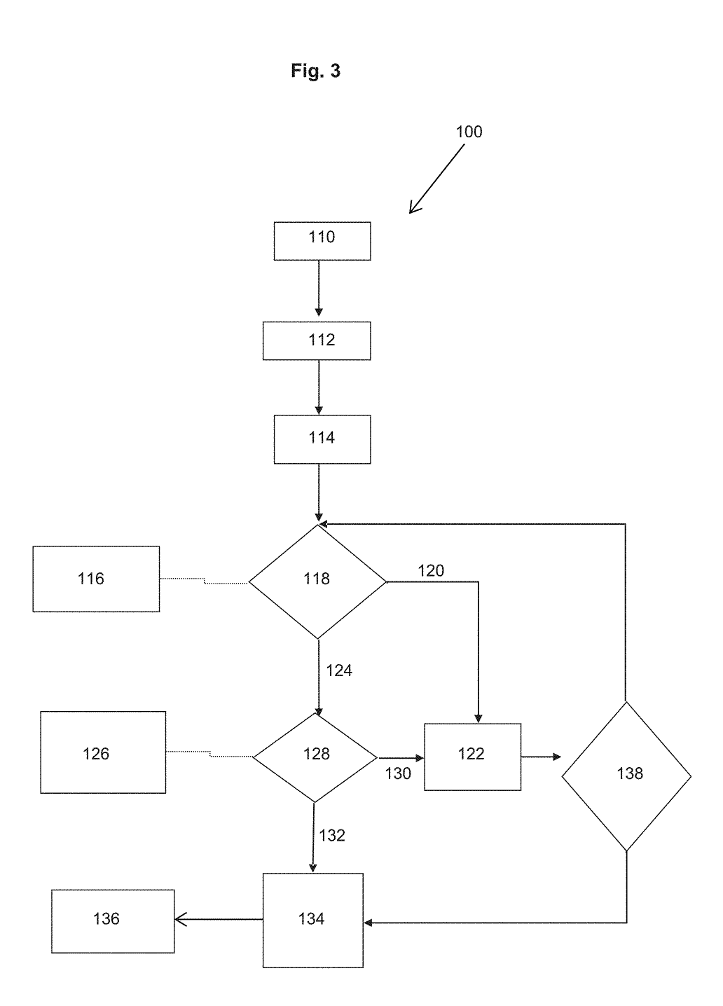

FIG. 3 shows a flow diagram 100 of the operation of the detection system. At 110 a bin is raised. At 112 the bin is emptied. At 114 the bin is starting to lower. AT 116 detection of moving objects or persons in the second zone 20 takes place. At 118 it is determined whether the second zone 20 is clear of moving objects or persons. If at 118 it is determined that the second zone 20 is not clear of moving objects or persons, the flow chart continues along 120 to 122. At 122 an audible alarm sounds and movement of the bin is stopped. If at 118 it is determined that the second zone 20 is clear of moving objects or persons, the flow chart continues along 124 to 128.

At 126 detection of moving or stationary objects or persons in the first zone 18 takes place. At 128 it is determined whether the first zone 18 is clear of moving or stationary objects or persons. If at 128 it is determined that the first zone 18 is not clear of moving or stationary objects or persons, the flow chart continues along 130 to 122. As mentioned above, at 122 an audible alarm sounds and movement of the bin is stopped. If at 128 it is determined that the first zone 18 is clear of moving or stationary objects or persons, the flow chart continues along 132 to 134.

At 134 the bin continues to lower until it reaches its original lowered position. After the bin has reached its original lowered position, the flow chart continues from 134 to 136. At 136 the detection system resets.

If the alarm sounds and movement of the bin is stopped at 122, the flow chart continues to 138. At 138 the flow chart returns to 118 unless the driver initiates a manual override. If the driver initiates a manual override, the flow chart continues to 134. It will be appreciated that the flow chart will continue to loop from 138 through 118 or 128 to 138 until it is determined that the first zone 18 is clear of moving or stationary objects or persons and that it is determined that the second zone 20 is clear of moving objects or persons, or until the driver initiates the manual override.

In use with reference to FIGS. 2 and 3, the tines 12 are positioned within side pockets of a bin (not shown) and the bin is raised when the lifting arm 11 is raised. The bin is maintained at a substantially horizontal orientation so that waste is not spilled from the bin. The bin is raised and proceeds in a substantially arc path as it passes over the top of the cabin 14. At a predetermined position, the bin is tilted and the waste is emptied into the hopper 13. The waste is subsequently compacted and stored for later disposal. After the bin is emptied of its waste, it is returned to a substantially horizontal orientation and follows the arc path for return to its original position on the ground.

While the bin is being lowered, it is maintained in a substantially horizontal orientation. The sensors 16 serve to detect the movement of an object or person in front of the vehicle and optionally the presence of a person or object in front of the vehicle. The spacing of the sensors 16 from each other provides the widest and uninhibited view of the area or space immediately in front of the vehicle. The sensor input is processed by a processor or programmable logic controller (PLC) into two distinct zones, the first zone 18 and the second zone 20.

The programming in the processor of the control means, defines the first zone 18 and the second zone 20 and what sensor input is used with respect to monitoring the first zone 18 and the second zone 20. In the preferred embodiment, input from the motion sensors of the sensors 16 is used to monitor the detection of movement of a person or object in the second zone 20. The proximity sensors and motion sensors of the sensors 16 provide input used for the monitoring of the detection of the presence or movement of an object or person in the first zone 18.

After the bin has emptied its waste into the hopper 13 of the waste collection vehicle 10, the bin is lowered from the raised position over the top of the cabin 14. As the bin is lowered, the control means takes notice of any sensor input whether it be the detection of the presence or the movement of an object or person. If an object or a person(s) is detected in the first zone 18 or movement of an object or person(s) are detected in the second zone 20, the lowering of the bin stops. If the sensors 16 detect an object or a person, there is also an audible alarm alerting the driver and others to the possibility of a problem. There maybe also flashing lights and other warning signals initiated when a person or object is detected by the sensors 16. The lowering of the bin will not resume until the sensors 16 no longer detect the presence or movement of an objection or person and/or the driver initiates a manual override. When the bin is lowered to the ground, the detection system is automatically reset in preparation for the lowering of the next bin.

In another embodiment an audible alarm or warning lights may be activated where the presence of an object or person or the movement of an object or person is detected in Zone A but without stopping the lowering of the arms.

### Advantages

An advantage of the preferred embodiment of the detection system includes preventing accidentally placing a bin on an object or causing injury to a person. The detection system of the preferred embodiment has the advantage that it can be retro-fitted to existing waste collection vehicles, thereby increasing the safety to all those around the waste collection vehicle.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A detection system for the front of a vehicle with front lift arms for lifting and lowering a bin and including
two sensors that are spaced apart and positioned on a front of the vehicle to detect a presence of an object or person;
control means to receive and process sensor input to control the operation of the lifting arms wherein when the presence of the object or person is detected the movement of the lifting arms is stopped,
wherein the detection system defines a first zone covering a space through which the bin moves between a raised and a lowered position, wherein the movement of the lifting arms is stopped when a person or object is detected within the first zone.

2. A detection system as claimed in claim 1, wherein the detection system defines a second zone, the second zone being the space surrounding the first zone.

3. A detection system as claimed in claim 2, wherein an alarm is activated when the presence of the object or person is detected in the second zone.

4. A detection system as claimed in claim 2, wherein an alarm is activated when the presence of the object or person is detected in the first zone or when the object or person is detected moving in the second zone.

5. A detection system as claimed in claim 2, wherein the movement of the lifting arms is stopped when a person or object is detected moving within the second zone.

6. A detection system as claimed in claim 3, wherein the alarm includes an audible alarm.

7. A detection system as claimed in claim 3, wherein the alarm includes a warning light.

8. A detection system as claimed in claim 7 wherein the warning light is a flashing light.

9. A detection system as claimed in claim 2, wherein the two sensors are spaced apart and positioned to provide a wide uninterrupted view of the space of the first zone and the second zone.

10. A detection system as claimed in claim 1, wherein the control means includes a programmable logic controller and or a processor to process the sensor input.

11. A detection system as claimed in claim 1, further including actuation means to actuate the movement of the lifting arms in response to operational signals from the control means.

12. A detection system as claimed in claim 11 wherein the actuation means includes one or more hydraulic pistons operationally associated with each of the lift arms.

13. A vehicle with front lift arms for lifting and lowering a bin, the vehicle including a detection system as claimed in claim 1.

14. A waste collection vehicle with front lift arms for lifting and lowering a bin, the waste collection vehicle including:
a detection system having:
two sensors that are spaced apart and positioned on a front of the vehicle to detect the presence of an object or person; and
control means to receive and process sensor input to control the operation of the lift arms,
wherein the detection system defines a first zone covering a space through which the bin moves between a raised and a lowered position, wherein a movement of the lifting arms is stopped when the person or object is detected within the first zone.

15. A waste collection vehicle including:
front lift arms for lifting and lowering a bin; and
a detection system having two sensors that are spaced apart and positioned on a front of the vehicle to detect a presence of an object or person, and control means to receive and process sensor input from the two sensors to control the operation of the lifting arms,
wherein the detection system defines a first zone covering a space through which the bin moves between a raised and a lowered position, wherein in use, when the lifting arms are moving and when the presence of the object or person is detected within the first zone by the two sensors, the two sensors provide sensor input to the control means, and wherein the control means processes the sensor input and stops the movement of the lifting arms.

16. A waste collection vehicle as claimed in claim 14, wherein the detection system defines a second zone, the second zone being a space surrounding the first zone.

17. A waste collection vehicle as claimed in claim 16, wherein an audible alarm or warning light is activated when the presence of the object or person is detected in the second zone.

18. A waste collection vehicle as claimed in claim 16, wherein an audible alarm or warning light is activated when the presence of the object or person is detected in the first zone or when the object or person is detected moving in the second zone.

19. A waste collection vehicle as claimed in claim 16, wherein the movement of the lifting arms is stopped when a person or object is detected moving within the second zone.

20. A detection system or waste collection vehicle as claimed in claim 1, wherein the two sensors are positioned near headlights or indicator lights at the front of the vehicle.

21. A detection system or waste collection vehicle as claimed in claim 1, wherein the two sensors are located above front headlights of the vehicle.

22. A detection system or waste collection vehicle as claimed in claim 1, wherein the two sensors are located between 1 m and 1.5 m above a ground surface.
